(19) United States
(12) Patent Application Publication
(10) Pub. No.: US 2009/0216424 A1
(43) Pub. Date: Aug. 27, 2009

(54) DEVICE FOR A FUEL SYSTEM AT AN ENGINE POWERED VEHICLE

(76) Inventor: Steinar Kolnes, Sola (NO)

Correspondence Address: DORITY & MANNING, P.A., POST OFFICE BOX 1449, GREENVILLE, SC, 29602-1449, US

(21) Appl. No.: 12/159,264

(22) PCT Filed: Dec. 27, 2006
(86) PCT No.: PCT/NO2006/000498

§ 371 Date: Oct. 28, 2008

(30) Foreign Application Priority Data
Dec. 27, 2005 (NO) 20056202
Dec. 18, 2006 (NO) 20065844

(51) Int. Cl. F02D 41/00

(52) U.S. Cl. 701/103

(57) ABSTRACT

A device for a fuel system for a combustion, engine (M), in which a validation unit (V) is connected to a supply line (L) between a fuel reservoir (D) and the combustion engine (M), including means (DR₂) for recording the fuel consumption of the combustion engine (M); a data storage medium (S); means (DR₂) for sampling the fuel flowing to the combustion engine (M); means (A) for analysing the characteristic fuel features. Methods are also described for controlling the supply of fuel to a combustion engine (M) related to defined emission levels of combustion products of the type CO₂, NOₓ and CO and also solid particles.

### FIELD OF THE INVENTION

The invention relates to a device for a fuel system at an engine-powered vehicle, more particularly a validation unit which is connected to the fuel supply to the combustion engine of a vehicle in such a way that at least part of the fuel supplied to the engine will have to pass this validation unit in order that, on the basis of continuous or intermittent testing of the fuel flowing through the validation unit, if the fuel does not meet specific requirements, defined actions are taken, such as (A) cutting the supply, (B) reducing the supply, (C) reducing the performance of the engine in some other manner, (D) allowing limited driving, (E) measuring the amount of fuel used outside the defined, acceptable specifications for reporting to the driver or external users of such information, and/or (F) deducting the calculated emission of one or more defined combustion products from the vehicle from an allocated emission quota when there is not used a defined type of, preferably environmentally friendly, biofuel.

### BACKGROUND

There is an increasing concern over increased emissions of CO₂ and other combustion products, for example NOₓ, CO and solid particles, into the atmosphere with global warming as a consequence thereof. Therefore, the authorities in several countries have introduced incentives and reliefs in the taxation and charges on vehicles that do not contribute to an increase in the net emissions of, for example, CO₂ into the atmosphere. This has resulted in the fact that electrically powered cars, so-called EVs, and cars which can run on hydrogen are exempt from all the non-recurrent fees added to the selling price of a new car in some countries. A practice is also seen, in which EVs are exempt from VAT, parking charges in public parking, road toll and annual fee. In some regions EVs are also allowed to drive in bus lanes. These reliefs give great economic incentives to change from common, polluting vehicles to EVs. It is a general view that all cars that have zero emissions should have the same benefits as EVs. This applies to hydrogen-powered vehicles and also vehicles which may be run on biofuel, among others.

However, it is a fact that vehicles that run on hydrogen and biofuel can also run on normal fossil fuels such as petrol or diesel. By the very fact of the user of the car being able, from a purely technical point of view, to utilize fossil fuel, there is therefore a real risk that environmental cars, which have benefited from a tax reduction/exemption, do not provide any environmental gain after all, as it is often more user-friendly to drive on fossil fuel. To perform checks on vehicles out in the traffic to check the contents in the tank is costly and resource-demanding. When the risk of misuse being revealed is small, it could easily lead to the use of environmentally unfriendly fuel.

From GB 1245312 is known a fuel supply system for a vehicle, the vehicle being able to utilize various types of fuels, and the use of some tax-free types of fuel being allowed only in specific situations, for example when the vehicle is stationary/parked, a fuel selector being activated by the use of the brake system to switch from an ordinary fuel to an alternative fuel, each contained in a separate tank.

JP 8144807 discloses an engine control unit, it being known that the properties of the fuel are analysed therein. There is described a test tank for measuring vapour pressure in the fuel in question, in order then to use this information to adjust the fuel supply system of the engine.

U.S. Pat. No. 5,229,946 discloses a method of optimizing engine performance, this being done by, among other things, analysing the fuel. A plurality of defined engine strategy maps contains the desired engine performance characteristics. A map is selected by fuzzy logic techniques to evaluate selected engine sensor signals, and such a selection is substantially made when new fuel has been filled into the tank and the sensors have recorded a certain deviation from the defined, nominal values, as this may indicate that a different blend of fuel has been supplied to the engine.

### SUMMARY OF THE INVENTION

The invention has as an object to remedy or reduce at least one of the drawbacks of the prior art. Objects and advantages of the invention are set forth in part in the following description, or may be obvious from the description, or may be learned through practice of the invention.

The objects are achieved through features specified in the description below and in the claims that follow.

The invention relates to a validation unit connected to the fuel supply to the combustion engine of a vehicle in such a manner that at least part of the fuel being supplied to the engine will have to pass this validation unit, in order that, on the basis of continuous or intermittent testing of the fuel flowing through the validation unit, if the fuel does not meet specific requirements, defined actions are taken, for example (A) cutting the supply, (B) reducing the supply, (C) reducing the performance of the engine in some other manner, (D) allowing limited driving, (E) measuring the amount of fuel used outside the defined, acceptable specifications, for reporting to the driver or external users of such information, and/or (F) deducting the calculated emission of one or more defined combustion products from the vehicle from an allocated emission quota when there is not used a defined type of, preferably environmentally friendly, biofuel.

In the last-mentioned case (F) it is conceivable that the vehicle is purchased with a given emission quota per unit of driven distance, for example g/km. If a fuel is used emitting less than this quota, the quota account is increased, whereas the use of fossil fuel results in a decrease in the balance on the account. The vehicle may be provided with means for indicating how large a driving distance is at one's disposal with a future emission corresponding to, for example, the present average emission for the last defined period of time/distance driven/tanking etc. or with the use of ordinary fossil fuel. In a region with biofuel available, biofuel will ordinarily be used when driving, increasing the balance on the emission account. If ordinary fossil fuel is filled because biofuel is not available for example, the balance on the emission account will be reduced.

The device according to the invention may operate with various models of how an emission quota is established and kept account of. For example, accounting models may be integrated, giving time-limited or geographically limited possibility for larger emissions where the use of biofuel is impossible for climatic reasons (temperature) or the supply is limited due to the distribution apparatus etc. It is then conceivable that the localization of the vehicle is determined by means of GPS technique or corresponding means.

The device according to the invention, as it is described in what follows, may be installed on the fuel hose between the fuel tank and engine. The validation unit is preferably installed as close to the fuel inlet of the engine as possible, so that it will be easy for a control authority to check that the validation unit has not been disconnected. Sealing of screws and hose connections is also a possibility. The validation unit may also be designed as an integrated part of the engine itself, for example in connection with a fuel pump. Installed correctly, the validation unit will continuously or intermittently verify that the fuel used is within the specifications for it to be counted as environmentally friendly biofuel.

Biofuel has a different physical and chemical “signature” than fuels based on petroleum. Some of these characteristics may require sophisticated analysis, whereas others are easily identifiable.

Today there are three main groups of biologically produced fuels:
(1) biodiesel (made of vegetable and animal oils)
(2) bioethanol (produced by fermentation and distillation processes), and
(3) synthetic diesel, produced for example by gasification to synthesis gas and the use of a Fischer-Tropsch reactor.

Common to them all are that biofuel can be revealed by carbon-14 dating (C14). This is a relatively complicated, costly and time-consuming method which is not suitable for use in vehicle-based devices at the present time. But it is quite possible that C14 dating could become inexpensive and easily available some time in the future. However, there are several other parameters unique to biofuels. Synthetic diesel stands out by its chemical properties which coincide, to a great degree, with the properties of fossil diesel. Still, synthetic diesel has a property that distinguishes it clearly from ordinary diesel, the synthetic diesel being clear, almost like water, and it can thereby be identified by, among other things, measuring the light transmission.

Biodiesel is produced mainly of vegetable and animal oils. It has several parameters which are described in EN 14214.

Parameters not easily imitated by fossil fuel are:
The contents of ester: The requirement is minimum: 96.5%. Testing by means of chromatographic analysis in accordance with EN 1403.
Density: The requirement is 860-900 kg/m³. Testing with hydrometer in accordance with EN ISO 3675 or by the “Oscillating U-tube” method in accordance with EN ISO 12185.
Flash point: The requirement is minimum 120° C. Testing by the “Rapid equilibrium closed up” method in accordance with EN ISO 3679. In comparison petrol diesel has a much lower flash point, typically <59° C.
Oxygen content: Is not a requirement in EN 14214. Biodiesel contains a much higher oxygen content (8-12%), which has side effects such as easy degradability in nature, among other things. In addition a higher oxygen content gives cleaner combustion resulting in a lower CO content.

In the main, bioethanol is produced of biological sacchariferous or farinaceous agricultural products through a fermentation process. The concentration of ethanol is increased through distillation. In Europe bioethanol is regulated by prEN 15376:2006. In a new and revised edition of EN 228 up to 5% bioethanol is allowed in normal petrol (E5). From some “green” pumps there is also sold E85 consisting of up to 85% ethanol and 15% fossil petrol.

For admixture, the ethanol admixed is required to comply with, among other things, these limit values:
Ethanol content of min. 98.7% including other higher alcohols. Testing in accordance with EC/2870/2000—Appendix 2, Verfahren B
Other higher alcohols max. 2%. Testing in accordance with EC/2870/2000—Method III, EN 13132 or EN 1601
Methanol content max. 1%. Testing in accordance with EC/2870/2000—Method III, EN 13132 or EN 1601
In addition there are some limit values for water content (max. 0.3%), chlorine content etc. These are not unique to bioethanol.
If the composite product E85 is used, the requirement for the ethanol content will thereby be reduced to minimum 83.895%, other high alcohols to max. 1.7% and methanol content to max. 0.85%.
   Synthetic diesel:
At the time of filing of the application, applicant is not aware of any specific test parameters for synthetic diesel, but it is likely that carbon-14 dating (C14) and measuring of the light transmission could be used. As to light transmission, the use of particular colorants could give synthetic diesel typical features.

The present device according to the invention analyses the signature of the fuel to provide, for example, engine control parameters that may be used, for example, to stop the engine or reduce the engine performance if a fuel parameter, for example the flash point, falls outside a defined limit. Alternatively, fossil fuel may be used, but the system measures the amount consumed and provides a basis for balancing the emission quota and possible payment of an emission charge.

In a first aspect, the invention relates more specifically to a device for a fuel system for a combustion engine, in which a validation unit is connected to a supply line between a fuel reservoir and the combustion engine, characterized in that the device includes:
means for recording the fuel consumption of the combustion engine;
a data storage medium;
means for sampling the fuel flowing to the combustion engine;
means for analysing the characteristic fuel features.

Preferably, the device includes means for adjusting the fuel supply to the combustion engine.

The means for analysing the characteristic fuel features are preferably arranged for continuous analysis. Alternatively, they are arranged for intermittent analysis.

The means for adjusting the fuel supply to the combustion engine are preferably arranged to stop or limit the fuel supply.

To the validation unit is/are advantageously connected one or more of the following units:
a time recording unit;
an ambient and/or fuel temperature recording unit
a geographical position recording unit; and
a mileage recording unit.

Advantageously, the validation unit further includes:
a plurality of parameter sets specifying characteristic fuel features; and/or
a plurality of emission quota data sets, these being related to climatic and/or geographical conditions.

The plurality of emission quota data sets advantageously includes data for the emission of one or more of the gases CO₂, NOₓ and CO and also solid particles.

In a second aspect, the invention relates to a method of deducting emissions of combustion products from a combustion engine from an allocated emission quota, characterized in that the method includes the following steps:
connecting a validation unit to a supply line between a fuel reservoir and the combustion engine;
recording the current fuel consumption of the combustion engine at all times;
determining the characteristic features of the fuel related to the emission of one or more combustion products by continuous or intermittent analysis; and
deducting the emission of the combustion engine from a disposable emission quota.

The combustion products are preferably taken from the group consisting of the gases CO₂, NOₓ and CO and also solid particles.

Preferably, there is added, continuously or in steps, an additional quota defined by time unit is added to the disposable emission quota.

Preferably, the method further includes the step of:
transferring information about the emission quota balance to an external register.

The disposable emission quota is preferably dependent on the ambient temperature and/or geographical localization of the combustion engine, there being connected to the validation unit an ambient and/or fuel temperature recording unit and/or a geographical position recording unit.

In a third aspect, the invention relates to a method of controlling the fuel supply to a combustion engine, characterized in that the method includes the following steps:
connecting a validation unit to a supply line between a fuel reservoir and the combustion engine;
recording the current fuel consumption of the combustion engine at all times;
determining the characteristic features of the fuel related to the emission of combustion products by continuous or intermittent analysis;
comparing the current emission of combustion products of the combustion engine in a specific period with a predefined permitted maximum emission; and
when an emission limit is exceeded, overriding the fuel supply to the combustion engine, overriding including limiting or stopping the fuel supply, adjusting the output of the combustion engine, limiting the combustion engine operation time and/or limiting the driving distance of a vehicle.

The maximum emission of combustion products allowed in advance is preferably dependent on the ambient temperature and/or geographical localization of the combustion engine, there being connected to the validation unit an ambient and/or fuel temperature recording unit and/or a geographical position recording unit.

Even though, in the above, reference has been made partly to a combustion engine placed in a vehicle, the object of the invention will also apply to other combustion engines, for example placed in a vessel or stationary ones, and parameters relating to the distance driven may just as well be related to the distance sailed, engine running time and the like.

### BRIEF DESCRIPTION OF THE DRAWINGS

In what follows is described an example of a preferred embodiment which is visualized in the accompanying drawing, in which:

FIG. 1 shows schematically a vehicle including a device according to the invention and also a temporarily connected external register for vehicle- and fuel-specific parameters; and

FIG. 2 shows schematically corresponding to FIG. 1, but in which there is also a CO₂ quota register temporarily connected.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

Even though apparatus and methods related to emissions of CO₂ are described here, it is obvious to a person skilled in the art that the equivalent may apply to emissions of any combustion product from a combustion engine.

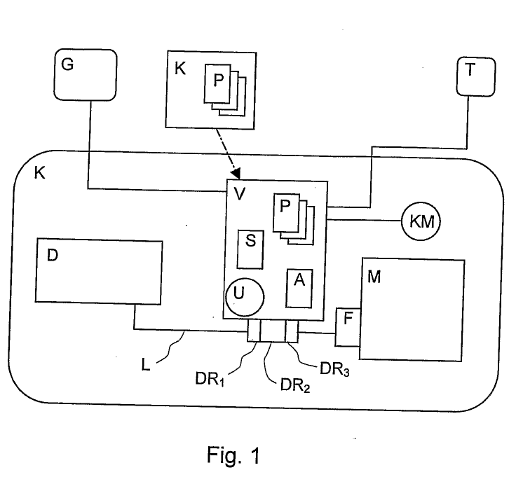

Reference is first made to FIG. 1, in which a vehicle K comprises a fuel reservoir D which is connected, in a manner known per se, to a combustion engine M via a supply line L and a fuel dosing system F.

In connection with the fuel line L and fuel dosing system F is arranged a validation unit V. The validation unit V comprises means DR₁ for recording the fuel consumption of the combustion engine M, means DR₂ for sampling the fuel flowing to the combustion engine M, and means DR₃ for adjusting the fuel supply to the combustion engine M.

Further the validation unit V comprises a data storage medium S, means A for analysing the characteristic fuel features, a time recording unit U and a plurality of parameter sets P specifying the characteristic fuel features for the pertinent combination of vehicle K and combustion engine M. The parameter set P is typically retrieved from a central register K by a temporary connection, for example a wireless connection by means of mobile phone technology known per se.

Further, the validation unit V is connected to a mileage recording unit KM, an ambient temperature recording unit T and a geographical position recording unit G, for example a so-called GPS (Global Positioning System) unit.

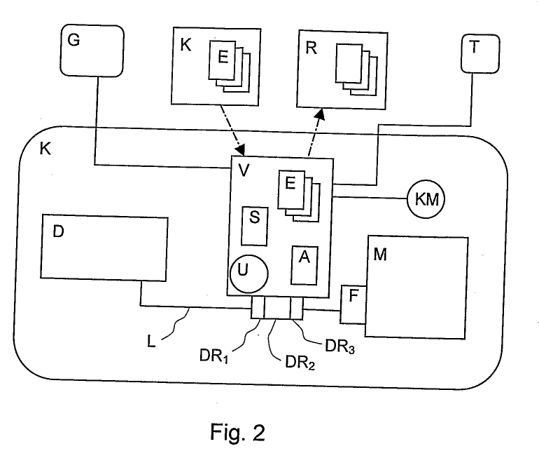

Reference is then made to FIG. 2, in which the validation unit V includes, instead of the plurality of parameter sets P, a plurality of CO₂ emission quota data sets E related to climatic and/or geographical conditions and retrieved from the central register K by a temporary connection. The validation unit V is arranged for temporary connection to an external register R for the transfer of data on CO₂ emissions for the calculation of charges, for example.

In a configuration according to FIG. 1, necessary data P concerning specific CO₂ emissions for the vehicle K or engine M are stored in connection with, for example, customs clearance of the engine M, the vehicle K in which the engine is used, possibly the vessel or other devices including a combustion engine M which is subject to fiscal accounting related to CO₂ emissions. This data P is typically provided by the fiscal authorities. If a fiscal regime implies that the permitted CO₂ emission is dependent on climatic conditions, typically the ambient temperature, and/or geographical location due to lack of distribution of biofuel, ambient temperature is recorded by means of the recording unit T and/or the geographical position by means of the recording unit G, and a corresponding data set P is selected. Specific fuel consumption, for example consumption per km or per hour, is calculated by means of the means DR₁ arranged therefor, and the fuel is analysed for relevant properties by means of the means DR₂, A. If analyses show that the CO₂ emission exceeds that defined in the parameter set P and forming the basis for fiscal accounting for vehicles etc., actions are taken, the means DR₃ for adjusting the fuel supply to the combustion engine M limiting or stopping the fuel supply, adjusting the output of the combustion engine, limiting the operation time of the combustion engine M and/or limiting the driving distance of the vehicle K in cooperation with, among other things, the fuel dosing system F of the engine M, which may be for example an injection system known per se.

In a configuration according to FIG. 2, necessary data E concerning maximum permitted emission of CO₂ for the specific vehicle K or the engine M is stored in the same way as that mentioned above for the data P. Also the data E is typically provided by the fiscal authorities. The fiscal regime may typically define a CO₂ quota per distance driven, per time unit or similar, which is defined in the engine-specific data set E. When the engine M is used, the validation unit V calculates the CO₂ emission, which is deducted from the built-up quota. When, in terms of emissions, a beneficial fuel is chosen, there is recorded a CO₂ emission resulting in the quota balance balancing or increasing, whereas the use of a fuel giving an unfavourable CO₂ balance, leads to a reduction in the quota balance. When there is a negative quota balance which is recorded by temporary connection to the register R, the basis is formed for payment of an additional charge for emission generated beyond that forming the basis for the calculation of non-recurrent fees etc. determined on customs clearance or registration of the vehicle K/vessel/engine M.

It is also conceivable that the latter configuration is combined with intervention in the fuel supply to the combustion engine M, as it is described for the configuration according to FIG. 1, when a quota balance of a certain negative magnitude has been built up.

It should be readily appreciated by those skilled in the art that various modifications and variations can be made to the embodiments of the method and systems described herein. It is intended that the present invention encompass such modifications and variations as come within the scope of the appended claims and their equivalents.

1-15. (canceled)

16. A fuel validation system for a combustion engine, comprising:
a validation unit configured for placement between a fuel reservoir and the combustion engine, said validation unit further comprising:
means for recording fuel consumption for the combustion engine;
data storage means;
means for sampling fuel flowing from the fuel reservoir to the combustion engine;
means for continuously analyzing characteristics of the sampled fuel, said analyzing means further comprising a plurality of parameter sets specifying characteristic fuel features, and a plurality of data sets for specified quotas of noxious emissions of any combination of CO₂, NOₓ, CO, and solid particles for the combustion engine.

17. The system as in claim 16, wherein said validation unit further comprises means for adjusting the fuel supply to the combustion engine in response to results from said analyzing means.

18. The system as in claim 17, wherein said adjusting means is configured to limit or stop flow of fuel from the fuel reservoir to the combustion engine.

19. The system as in claim 16, wherein said validation unit is further configured with any combination of a time recording unit, an ambient temperature recording unit, a fuel temperature recording unit, a geographical position recording unit, and a mileage recording unit.

20. A fuel validation system for a combustion engine, comprising:
a validation unit configured for placement between a fuel reservoir and the combustion engine, said validation unit further comprising:
a recording device that records fuel consumption for the combustion engine;
data storage means;
a device configured to sample fuel flowing from the fuel reservoir to the combustion engine;
an analyzing device configured to continuously analyze characteristics of the sampled fuel, said analyzing device further comprising a plurality of parameter sets specifying characteristic fuel features, and a plurality of data sets for specified quotas of noxious emissions of any combination of CO₂, NOₓ, CO, and solid particles for the combustion engine.

21. The system as in claim 20, wherein said validation unit further comprises a device to adjust the fuel supply to the combustion engine in response to results from said analyzing means.

22. The system as in claim 21, wherein said adjusting device is configured to limit or stop flow of fuel from the fuel reservoir to the combustion engine.

23. The system as in claim 20, wherein said validation unit is further configured with any combination of a time recording unit, an ambient temperature recording unit, a fuel temperature recording unit, a geographical position recording unit, and a mileage recording unit.

24. A method for controlling the flow of fuel in a combustion engine, comprising:
connecting a validation unit between a fuel reservoir and the combustion engine;
continuously recording fuel consumption of the combustion engine analyzing the fuel being consumed by the combustion engine to determine emission product characteristics of the fuel;
comparing the emission product characteristics of the fuel over a defined time period to predefined emission limits;
in the event that an emission limit is exceeded, restricting operation of the combustion engine by any combination of limiting or stopping the supply of fuel from the reservoir to the combustion engine; adjusting the output of the combustion engine; limiting operation time of the combustion engine; and limiting driving distance of a vehicle utilizing the combustion engine.

25. The method as in claim 24, wherein the predefined emission limits are a function of ambient temperature of the combustion engine, the method further comprising monitoring ambient or fuel temperature.

26. The method as in claim 24, wherein the predefined emission limits are a function of geographical location of the combustion engine, the method further comprising monitoring geographical location of the combustion engine.
